(19) United States
(12) Patent Application Publication
(10) Pub. No.: US 2024/0334398 A1
(43) Pub. Date: Oct. 3, 2024

(54) MULTIPLE PAYLOAD REGIONS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US); Wei YANG, San Diego, CA (US); Krishna Kiran MUKKAVILLI, San Diego, CA (US)

(21) Appl. No.: 18/191,837

(22) Filed: Mar. 28, 2023

(51) Int. Cl. H04W 72/044; H04B 1/00; H04L 5/00; H04W 72/231; H04W 72/541

(52) U.S. Cl. CPC H04W 72/044; H04B 1/0064; H04L 5/0044; H04W 72/231; H04W 72/541

(57) ABSTRACT

Aspects of the disclosure are directed to an apparatus and method of communication between a user equipment (UE) and a network node using multiple transport blocks that are split across disjointed or overlapping resources. In one examples, the UE may receive downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples the UE may receive a first downlink signal via the first set of downlink resources, and a second downlink signal via the second set of downlink resources.

### BACKGROUND

### Technical Field

The present disclosure generally relates to wireless communication systems, and more particularly, to transmission of data via multiple payload regions.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a user equipment (UE) configured for wireless communication. In some examples, the UE includes a memory comprising instructions and one or more processors configured to execute the instructions. In some examples, the one or more processors are configured to cause the UE to receive downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the one or more processors are configured to cause the UE to receive: a first downlink signal via the first set of downlink resources, and a second downlink signal via the second set of downlink resources.

Certain aspects are directed to a network node configured for wireless communication. In some examples, the network node includes a memory comprising instructions and one or more processors configured to execute the instructions. In some examples, the one or more processors are configured to cause the network node to transmit downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the one or more processors are configured to cause the network node to transmit: a first downlink signal via the first set of downlink resources, and a second downlink signal via the second set of downlink resources.

Certain aspects are directed to a method for wireless communication at a user equipment (UE). In some examples, the method includes receiving downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the method includes receiving: a first downlink signal via the first set of downlink resources, and a second downlink signal via the second set of downlink resources.

Certain aspects are directed to a method for wireless communication at a network node. In some examples, the method includes transmitting downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the method includes transmitting: a first downlink signal via the first set of downlink resources, and a second downlink signal via the second set of downlink resources.

Certain aspects are directed to an apparatus for wireless communication. In some examples, the apparatus includes means for receiving downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the apparatus includes means for receiving: a first downlink signal via the first set of downlink resources, and a second downlink signal via the second set of downlink resources.

Certain aspects are directed to an apparatus for wireless communication. In some examples, the apparatus includes means for transmitting downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the apparatus includes means for transmitting: a first downlink signal via the first set of downlink resources, and a second downlink signal via the second set of downlink resources.

Certain aspects are directed to a non-transitory computer-readable medium having instructions stored thereon that, when executed by a user equipment (UE), cause the UE to perform a method of wireless communication. In some examples, the method includes receiving downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the method includes receiving: a first downlink signal via the first set of downlink resources, and a second downlink signal via the second set of downlink resources.

Certain aspects are directed to a non-transitory computer-readable medium having instructions stored thereon that, when executed by a network node, cause the network node to perform a method of wireless communication. In some examples, the method includes transmitting downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources. In some examples, the method includes transmitting: a first downlink signal via the first set of downlink resources, and a second downlink signal via the second set of downlink resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram conceptually illustrating time-frequency resources for in-band full duplex (IBFD) wireless communication schemes.

FIG. 6 is a block diagram conceptually illustrating time-frequency resources for a subband full duplex (SBFD) wireless communication scheme.

FIG. 7 is a block diagram conceptually illustrating example time-frequency resources for an SBFD wireless communication scheme.

FIG. 8 is a block diagram conceptually illustrating example time-frequency resources for an SBFD wireless communication scheme.

FIG. 9 is a block diagram conceptually illustrating example time-frequency resources for an SBFD wireless communication scheme.

FIG. 10 is a block diagram conceptually illustrating example time-frequency resources for an SBFD wireless communication scheme.

FIG. 11 is a block diagram conceptually illustrating example time-frequency resources for an SBFD wireless communication scheme.

FIG. 12 is a call-flow diagram illustrating example communications between a UE and a network node.

FIG. 13 is a flowchart of a method of wireless communication.

FIG. 14 is a diagram illustrating an example of a hardware implementation for an example apparatus.

FIG. 15 is a flowchart of a method of wireless communication.

FIG. 16 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Wireless communication, including cell-based communications, may include different types of full duplex communications. For example, in-band full duplex (IBFD) may operate to transmit and receive on the same time and frequency resources. In this example, a user equipment (UE) may transmit an uplink signal and receive a downlink signal transmitted by a network node, wherein the uplink signal and the downlink signal are each transmitted via at least one common time and frequency resource (e.g., at least one resource block (RB) is used for transmission of both the uplink and downlink signals).

In another example, full duplex communications may be achieved using subband frequency division duplexing (FDD) (SBFD). In SBFD, the UE and network node may transmit and receive at the same time but on different frequency resources. For example, a downlink resource (e.g., downlink subchannel) may be separated from an uplink resource (e.g., uplink subchannel) in the frequency domain, but both may share a common time domain. In some examples, a guard band may separate the two subchannels, as described in more detail below.

In some examples, an SBFD slot may have two disjointed downlink allocations or two disjointed uplink allocations. For example, the two disjointed downlink/uplink allocations (e.g., two downlink/uplink subchannels) may be separated by an uplink/downlink allocation (e.g., single uplink/downlink subchannel) in addition to an optional guard band. However, in such an example, the downlink/uplink resources on the edge with the uplink/downlink resources may experience interference (e.g., cross-link interference (CLI) or self-interference). As such, when the UE is scheduled with a transmission of two or more transport blocks (TBs), two TBs may be mapped to the same resources (e.g., two TBs may be overlapped). Thus, even though the interference is structured by the SBFD slot, both TBs are subject to the same interference.

Thus, aspects of the disclosure are directed to a TB split, wherein one TB is mapped to resources of a downlink subband that are adjacent to an uplink subband and/or guard band, and another TB is mapped to resources of the downlink subband that are separated from the uplink subband and/or guard band by the other TB. This way, appropriate communication parameters may be assigned to each TB that best fit the channel conditions.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

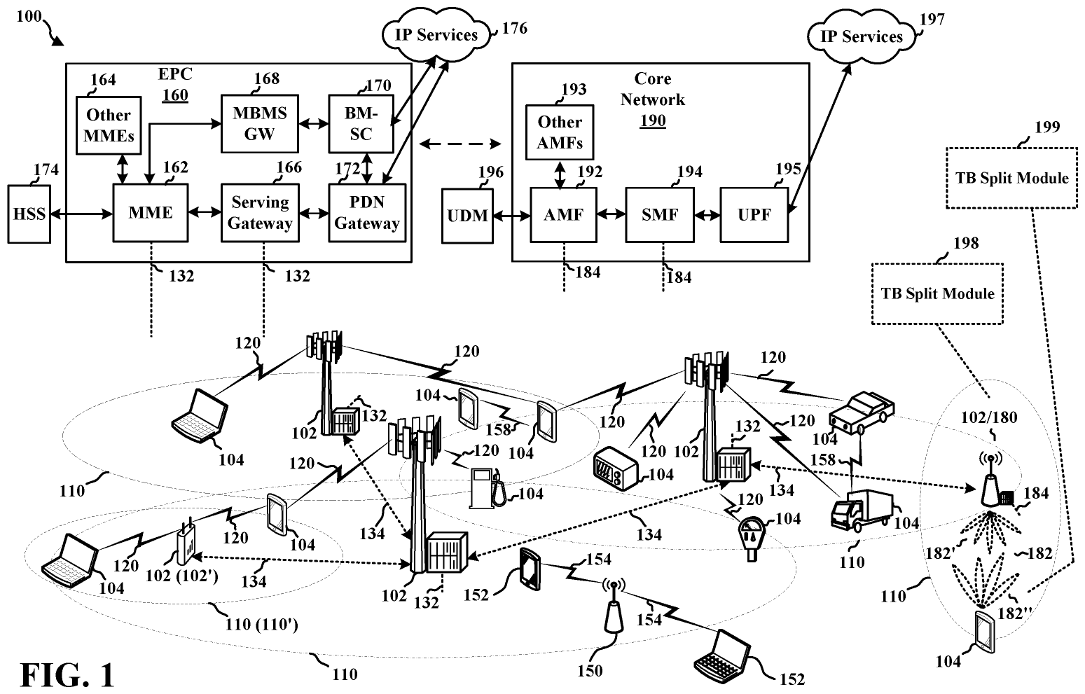

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing. Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring to FIG. 1, in certain aspects, the UE 104 may be configured with a TB split module 199 configured to receive downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and receive: a first downlink signal via the first set of downlink resources, and a second downlink signal via the second set of downlink resources.

Referring again to FIG. 1, in certain aspects, the base station 102/180 may be configured with a TB split module 198 configured to transmit downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and transmit: a first downlink signal via the first set of downlink resources, and a second downlink signal via the second set of downlink resources.

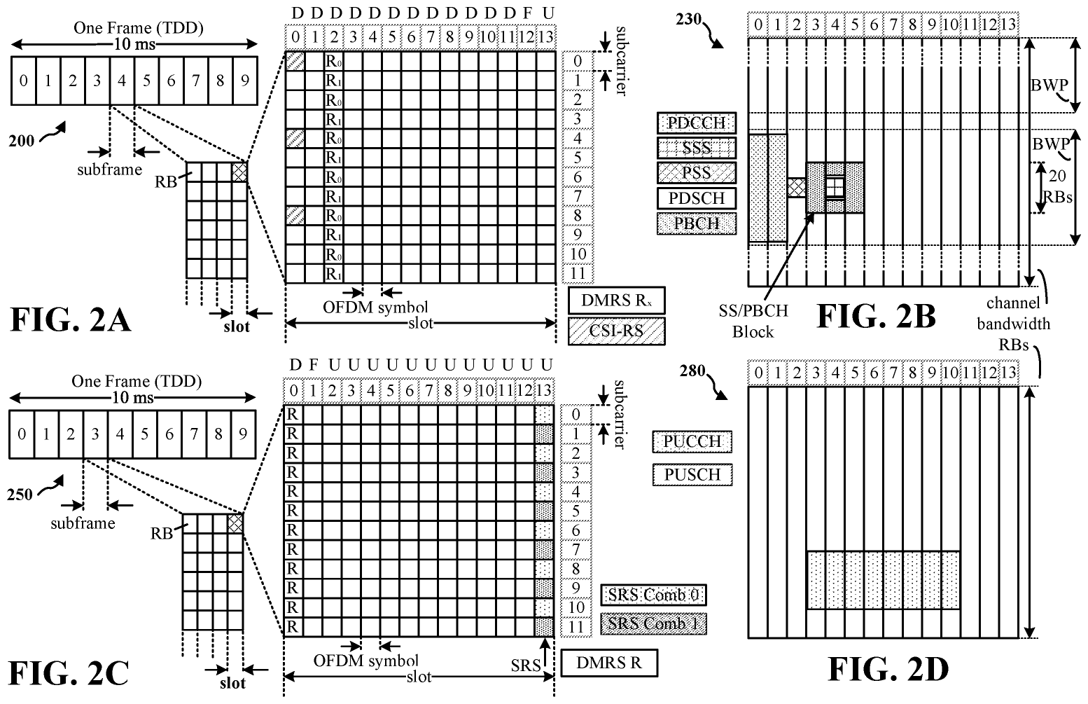

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

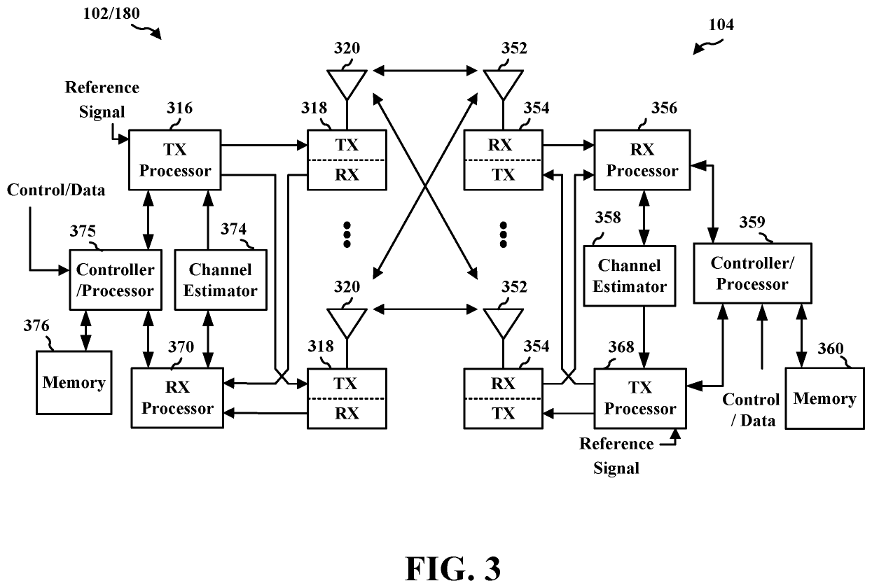

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

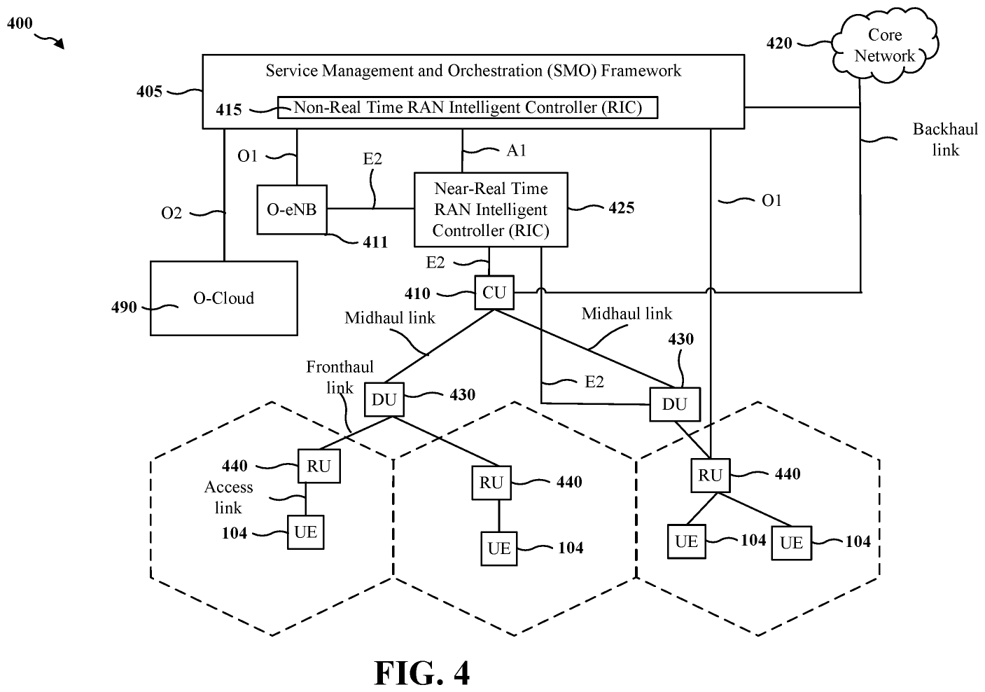

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open cNB (O-CNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an Al interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

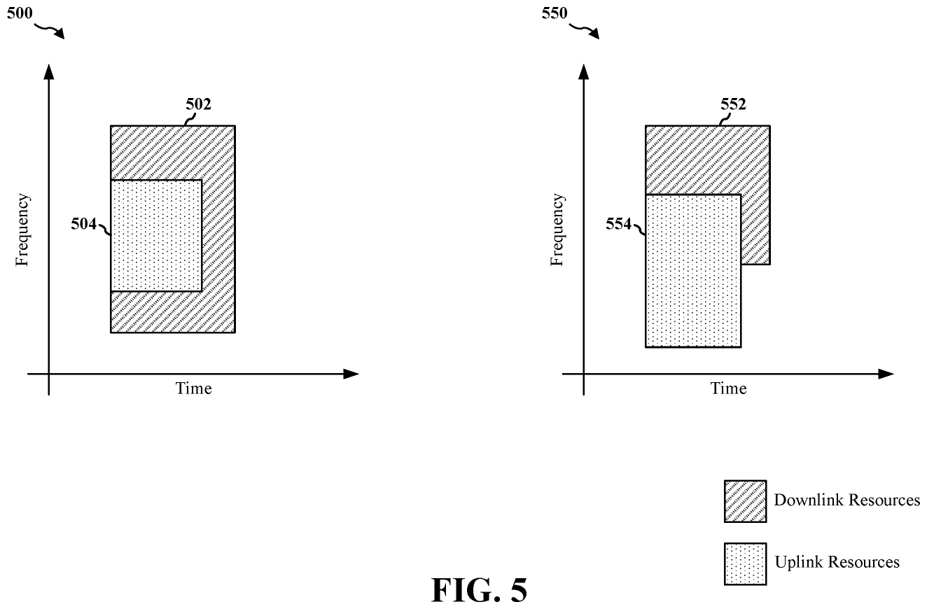

FIG. 5 is a block diagram conceptually illustrating time-frequency resources for in-band full duplex (IBFD) wireless communication schemes. A first in-band scheme 500 shows a full overlap of downlink resources 502 and uplink resources 504 in time and frequency. The downlink resources 502 and uplink resources 504 may be resources used for a UE-to-UE communication link or a UE-to-gNB communication link. A second in-band scheme 550 shows a partial overlap of downlink resources 552 with uplink resources 554. Here, the downlink resources 552 and the uplink resources 554 are offset from each other by frequency and/or time.

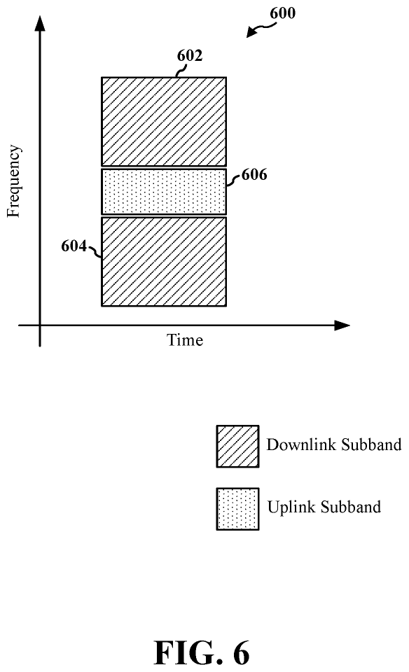

FIG. 6 is a block diagram conceptually illustrating time-frequency resources for an SBFD wireless communication scheme. Here, an SBFD slot 600 includes an allocated first downlink subband 602 and an allocated second downlink subband 604, as well as an allocated uplink or guard band subband 606. Thus, from the perspective of a UE, a first antenna array is dedicated to downlink reception for the SBFD slot whereas a second antenna array is dedicated to uplink transmission. Note that neither the uplink subband 606 nor the downlink subbands 602/604 in the SBFD slot 600 may occupy the entire frequency resource range (e.g., the frequency band) for these slots. Instead, the uplink subband 606 occupies a central subband in the frequency band for the SBFD slot, and the downlink subbands 602/604 occupy a lower subband that ranges from: (i) the lower frequency of the frequency band up to a lowest frequency for the uplink subband, and (ii) an upper subband in the frequency band to a greatest frequency for the uplink subband. It will be appreciated however, that the subbands may be separated by a guard band.

In one embodiment, the uplink subband 606 may be symmetric about a center frequency for the SBFD slot 600. In such an embodiment, the bandwidth for the downlink lower subband 604 and the downlink upper subband 602 may be equal. However, in alternative embodiments, the downlink lower subband 604 bandwidth may be different from the bandwidth for the downlink upper subband 602.

Thus, an SBFD slot is a slot in which the frequency band is used for both uplink and downlink transmissions. The uplink and downlink transmissions can occur in adjacent bands (e.g., subbands) as opposed to an IBFD communication with overlapping bands. In a given SBFD slot, a half-duplex UE may either transmit in the uplink band or receive in the downlink band, while a full duplex UE may transmit in the uplink band and/or receive in the downlink band of the same slot.

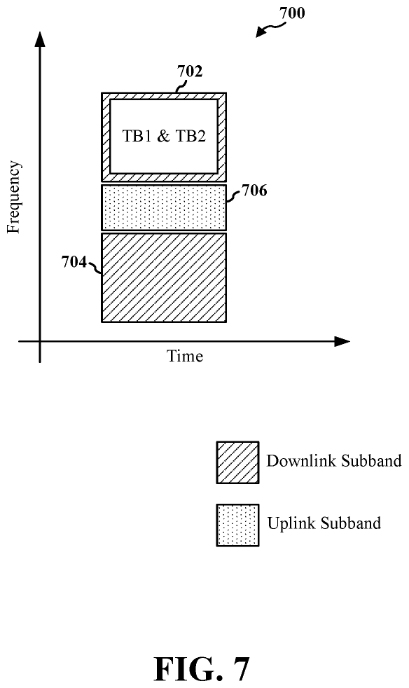

In certain aspects, a network (e.g., a base station 102/180 or a disaggregated network node of a base station) may configure a UE with frequency-domain resource allocation for an SBFD slot. For example, as illustrated in FIG. 7, the network may allocate frequency-domain resources for a first transport block (TB—e.g., TB1) and a second TB (e.g., TB2) such that the TB1 and TB2 overlap within the downlink upper subband 702. Thus, in this example, the TB1 and TB2 may be allocated to share the same downlink frequency resources of an SBFD slot 700. It should be noted that TB1 and TB2 may be allocated fewer than all frequency-domain and/or time-domain resources available in the downlink upper subband 702. Although multiple TBs are illustrated in the upper subband, the lower subband 704 may also include resources allocated to downlink TBs.

The network may communicate an allocation of frequency-domain resources for one or more of the downlink upper subband 702, the downlink lower subband 704, and/or the uplink subband 706 to the UE. In a first example, such an allocation may be communicated to the UE via a downlink control information (DCI) message (e.g., DCI formats 0_0 and 0_1). Here, the network may transmit the DCI message via PDCCH. The DCI message may include a frequency domain resource assignment (FDRA) field used to specify a set of allocated resource blocks (RBs). In one example, the FDRA may indicate to the UE which RBs the network will use to transmit TB1 and TB2. In a second example, an allocation of resources may be communicated to the UE via radio resource control (RRC) signaling. The RRC signaling may include a field or information element (e.g., frequencyDomainAllocation) used to specify a set of allocated RBs for configured grant allocations.

### Example Wireless Communications Via Multiple Distinct Payload Regions

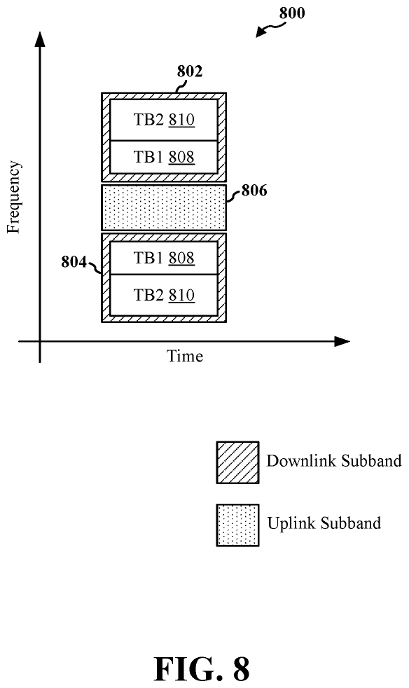

FIG. 8 is a block diagram conceptually illustrating time-frequency resources for an SBFD wireless communication scheme. Similar to the example shown in FIG. 7, a UE may be scheduled with multiple TBs (e.g., TB1 808 and TB2 810) in an SBFD slot 800. The multiple TBs may be located in one or more of a downlink upper subband 802 and/or a downlink lower subband 804. As illustrated, the multiple TBs may be mapped to disjointed resources (e.g., separate time- and frequency-domain resources). In other words, each of the multiple TBs use separate resources (e.g., as opposed to the multiple TBs using the same resources, shown in FIG. 7).

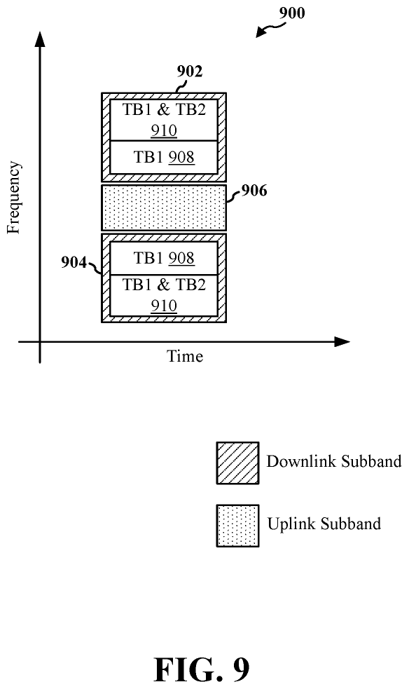

FIG. 9 is a block diagram conceptually illustrating time-frequency resources for an SBFD wireless communication scheme. Similar to the examples shown in FIGS. 7 and 8, a UE may be scheduled with multiple TBs (e.g., TB1 908 and TB2 910) in an SBFD slot 900. The multiple TBs may be located in one or more of a downlink upper subband 902 and/or a downlink lower subband 904. However, distinct from FIGS. 7 and 8, the TBs of a subband may have both overlapping resources (e.g., sharing at least one time- and frequency-domain resource) and separate resources. For example, TB1 908 occupies resources of the downlink upper subband 902 and the downlink lower subband 904 that are relatively close to the uplink subband 906. Whereas TB1 and TB2 910 share resources of the downlink upper subband 902 and the downlink lower subband 904 that are relatively further away (e.g., in terms of frequency) from the uplink subband 906.

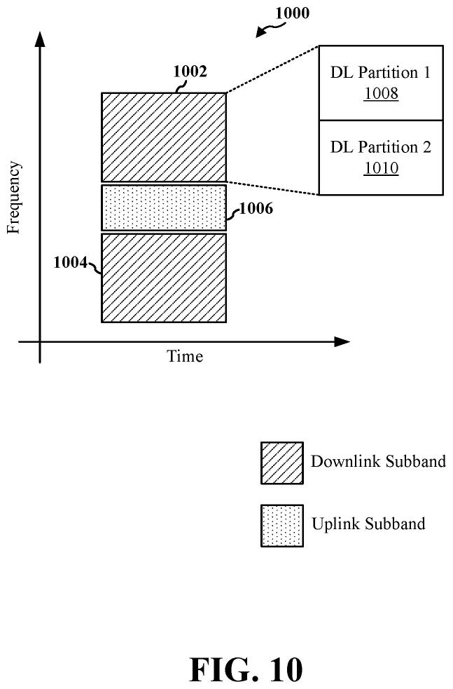

FIG. 10 is a block diagram conceptually illustrating time-frequency resources for an SBFD wireless communication scheme. In this example, the network may partition one or more of the downlink upper subband 1002 and the downlink lower subband 1004 of an SBFD slot 1000, and assign a particular TB to each partition. For example, the network may partition the downlink upper subband 1002 into a first downlink partition 1008 and a second downlink partition 1010. The multiple TBs may be located in one or more of a downlink upper subband 902 and/or a downlink lower subband 904. In some examples, the network may assign TB1 to the resources of the first downlink partition 1008, and TB2 to the second downlink partition 1010. In some examples, the network may assign one or more of TB1 and TB2 to less than all of the resources of a corresponding partition, as discussed in more detail below. In some examples, the network may assign one or more TBs to each partition. For example, the network may assign TB1 to the second downlink partition 1010, and assign both TB1 and TB2 to the first downlink partition 1008. Here, the network node may only assign a single TB to the partition that is closest to the uplink subband 1006 so that any potential interference caused by the uplink subband 1006 affects only a single TB instead of multiple TBs.

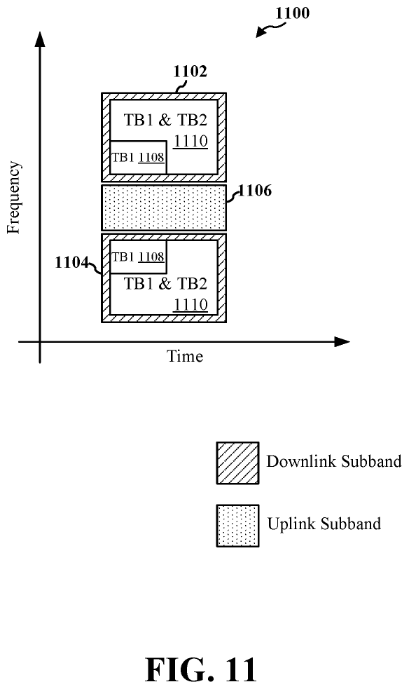

FIG. 11 is a block diagram conceptually illustrating time-frequency resources for an SBFD wireless communication scheme. In this example, the network may separate multiple TBs in both the time- and frequency-domain of one or more of the downlink upper subband 1102 and the downlink lower subband 1104 of an SBFD slot 1100. For example, as shown, the network may map TB1 1108 to a first region of the downlink upper subband 1102 and the downlink lower subband 1104, while mapping both TB1 and TB2 1110 to a second region of the downlink upper subband 1102 and the downlink lower subband 1104. The network node may assign a single TB to the region having the most resources closest to the uplink subband 1106 so that any potential interference caused by the uplink subband 1106 affects only a single TB instead of multiple TBs.

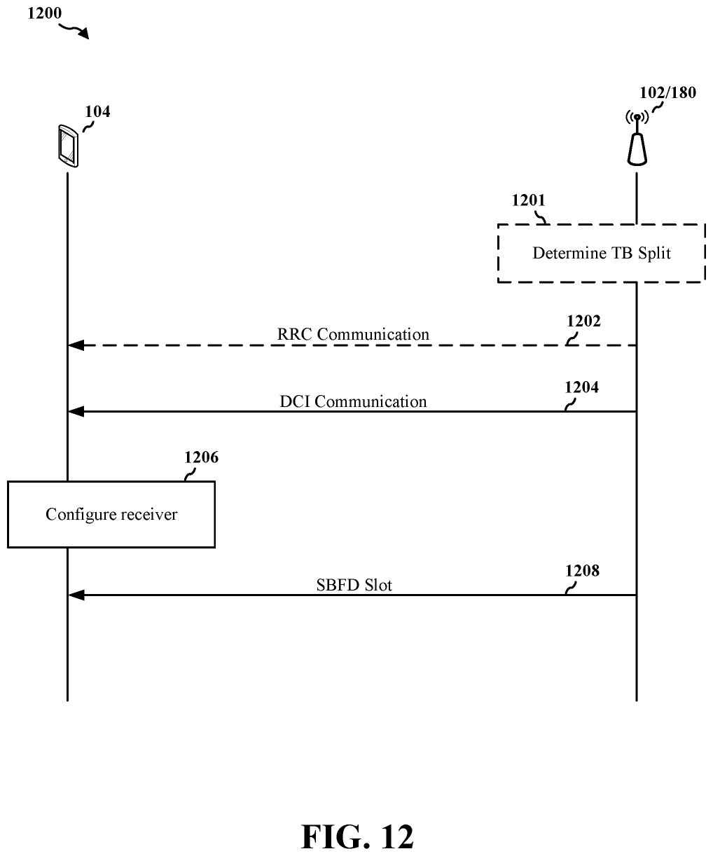

FIG. 12 is a call-flow diagram illustrating example communications 1200 between a UE 104 and a network node 102. Initially, the network node 102 may determine to split TB resource among multiple TBs in one or more subbands of an SBFD slot, at a first process 1201. For example, the network node 102 may determine to map resources to different TBs such that each of the multiple TBs use disjointed resources relative to other of the multiple TBs (e.g., as illustrated in FIGS. 8 and 10), or map resources such that some resources are shared among TBs and at least one other TB of the multiple TBs has unique resources relative to the other TBs (e.g., as illustrated in FIGS. 9 and 11). In some examples, the network node 102 may determine whether to partition TB resources of a downlink subband.

In an optional first communication 1202, the network node 102 may transmit, and the UE 104 may receive, an RRC message. Here, the RRC message may include an indication of whether the network node 102 will transmit a future communication using multiple downlink TBs in an SBFD slot, and whether the multiple TBs will be mapped to disjointed resources (e.g., as illustrated in FIGS. 8 and 10) or mapped to overlapping resources (e.g., as illustrated in FIGS. 9 and 11). Thus, the RRC message may indicate to the that the multiple TBs will not all use identical resources (e.g., as illustrated in FIG. 7).

At a second communication 1204, the network node 102 may transmit a DCI message to the UE 104. In this example, the network node 102 may partition subbands of a future SBFD slot and/or assign resources of the future SBFD slot to certain TBs (e.g., as illustrated and described in FIGS. 8-11). The DCI may be configured to indicate which resources of the SBFD slot map to one or more particular TBs, according to the resource assignments. In one example, a frequency domain resource assignment (FDRA) field within the DCI may be used by the network node 102 to specify a set of allocated resource blocks (RBs) that correspond to a downlink transmission in a downlink subband. However, the FDRA field of the DCI may only provide the UE 104 with an indication of the entire TB region of a particular subband. For example, the FDRA field may indicate both TB1 808 and TB2 810 of the downlink upper subband 802 of FIG. 8, but may not provide the UE 104 with an indication of where in the region TB1 starts and ends, or where TB2 starts and ends.

Similarly, a frequencyDomainAllocation information element (IE) within RRC signaling protocol can be used to specify the set of allocated RBs (e.g., when using configured grant resource allocations). As such, the network node 102 may indicate the resource assignments or allocations of TBs via one or more of the optional first communication 1202 via RRC or the second communication 1204 via DCI.

Thus, in some examples, the network node 102 may provide, via the optional first communication 1202, an RRC configuration message configured to indicate a threshold number of RBs within one or more of the downlink upper subband and/or the downlink lower subband starting at from the entire TB region as indicated by the frequencyDomainAllocation IE. In other words, the threshold number of RBs may begin at the boundary of the entire TB region that is closest to the uplink band of the SBFD slot. Using FIG. 8 as an example, the frequencyDomainAllocation IE of the optional first communication 1202 may provide the UE 104 with an indication of the entire TB region (e.g., TB1 808 and TB2 810), but the IE may not indicate where TB1 and TB2 start and end. However, another field of the RRC message of the optional first communication 1202 may provide the UE 104 with the threshold number of RBs. Thus, the threshold number of RBs may indicate to the UE 104 the number of RBs that are assigned to TB1 808. The UE 104 can then assume that any remaining resources of the entire TB region are allocated to TB2 810. Because the threshold number of RBs begin at the boundary of the entire TB region closest to the uplink subband 806, the threshold number of RBs correspond to TB1 808.

In another example, the network node may provide the threshold number of RBs to the UE 104 via the DCI message of the second communication 1204. Thus, the DCI message that provides the UE 104 with the scheduled SBFD slot may also provide the UE 104 with the threshold for determining TB locations within downlink subbands. It should be noted that the DCI may allow the network node to dynamically assign threshold values (e.g., network node 102 may assign a different value with every DCI), while an RRC configuration may provide a relatively static threshold value that the network node 102 does not have to update in a DCI. In some examples, the network node 102 may configure the UE 104 to use a first threshold number of RB via RRC configuration, then override the first threshold with a second threshold provided to the UE 104 via DCI. Thus, if a DCI omits a threshold RB value, the UE 104 may use the first threshold number of RBs.

In some examples, if the allocation (e.g., the entire TB region) is smaller than the threshold RB value, then the UE 104 may not perform any splitting of TB mapping in the corresponding subband. In some examples, the RRC message and/or the DCI message may provide the threshold number of RBs to the UE 104 via an explicit indication of the number of RBs. Alternatively, the RRC message and/or the DCI message may provide the threshold number of RBs to the UE 104 via an index value that maps to a row in a look-up table. The row in the look-up table may provide the threshold number of RBs corresponding to the index value. In this example, the optional first communication 1202 may configure the UE 104 with the look-up table.

In certain aspects, the network may configure a downlink transmission via an SBFD slot such that multiple TBs are transmitted in a downlink subband, wherein one or more of the multiple TBs are mapped to unique downlink resources relative to the other TB(s) and each of the multiple TBs also share downlink resources with the other TB(s). For example, FIGS. 9 and 11 illustrate examples of SBFD slots wherein at least one TB is assigned downlink resources that are unique relative to another TB, while also sharing other downlink resources with the other TB. Similarly, FIG. 10 illustrates such an example if the network maps a first TB to a first partition and maps the first TB and a second TB to a second partition.

In this example of overlapping resources, the network node 102 may determine a mapping of TBs to resources within an SBFD slot, and configure the UE 104 with the mapping via the optional first communication 1202 and/or the second communication 1204 as described above. In one example, the network node 102 may transmit an FDRA or frequencyDomainAllocation IE indicating the TB region of a downlink subband in an SBFD slot. In the same RRC message, the network node 102 may also provide an indication of a threshold number of RBs to the UE 104 indicating the mapping of TBs to resources within the TB region. In one example, the threshold number of RBs may indicate resources within the TB region mapped to a first TB (e.g., TB1). This may imply that remaining resources in the TB region (e.g., the TB region minus the threshold number of RBs) will be used for the first TB and a second TB (e.g., TB2).

For example, as illustrated in FIG. 9, the network node 102 may indicate the entire TB region (e.g., TB1 908 and TB1 & TB2 910) of one or more of the downlink upper subband 902 and the downlink lower subband 904 via an FDRA or frequencyDomainAllocation IE. The network node 102 may then provide an indication of the threshold number of RBs via an RRC message (e.g., optional first communication 1202). The UE 104 may map the threshold number of RBs to the portion of the TB region that borders the uplink subband 906. As such, the UE 104 may expect that the first TB will be received via region TB1 908 shown in FIG. 9. The UE 104 may also expect the remaining TB region to be used for TB1 & TB2 910. It should be noted that the network node 102 may configure the UE 104 with the which regions (e.g., the region defined by the threshold number of RBs and the region defined by the remaining TB region minus the threshold number of RBs) are mapped to which TB(s).

In another example, the network node 102 may configure the UE 104 with the threshold number of TBs via DCI message (e.g., the second communication), such as a DCI scheduling grant. It should be noted that in either the RRC or DCI example, the threshold number of RBs may be indicated with an explicit value identifying a specific of RBs, or via a row index of a look-up table as described above.

In the example of FIG. 10, the network node 102 may determine to partition a downlink subband of an SBFD slot at the first process 1201. In this example, the network node 102 may configure the UE 104 to recognize the partition by transmitting an indication of the partition via an RRC message (e.g., optional first communication 1202). As illustrated in the example of FIG. 10, the partition of the downlink upper subband 1002 creates two TB regions within the subband. As noted above, the TB regions may also be bounded by an FDRA or frequencyDomainAllocation IE (e.g., the TB region may be the entire subband region of the slot or may be bounded to less than all the subband resources). The RRC message may also indicate to the UE 104 which partition corresponds to which TB. For example, the network node 102 may configure the UE 104 to recognize the second downlink partition 1010 as corresponding to a first TB (e.g., TB1), and the first downlink partition 1008 as corresponding to at least a second TB (e.g., TB2) (e.g., the first downlink partition 1008 may correspond to multiple TBs, such as TB1 and/or a TB3).

As discussed in several of the examples above, the network node 102 may map a single TB to resources adjacent to an uplink subband, while mapping multiple TBs to resources relatively further away in the frequency-domain from the uplink subband. Mapping multiple TBs in resources further away from the uplink band may improve communication and throughput of those TBs because there is less opportunity for CLI and/or self interference from the uplink subband. It should also be noted that in addition to the frequency-domain aspect of the threshold number of RBs used to identify slit TBs, the network node may also indicate a time-domain value to the UE 104 (e.g., via RRC or DCI) in order to split the TB resources as illustrated in FIG. 11.

In certain aspects, the network node 102 may dynamically transmit an indication configured to inform the UE 104 of whether individual TBs are mapped to disjointed resources (e.g., as illustrated in FIGS. 8 and 10), or mapped to overlapping resources (e.g., as illustrated in FIGS. 9 and 11). The indication may be transmitted via the optional first communication 1202 or the second communication 1204. In one example, the network node 102 may provide the UE 104 with an indication that disjointed resources will be used via RRC, then dynamically change to overlapping resources for a future slot by informing the UE 104 via a DCI message.

In certain aspects, the network node 102 may transmit an indication of a modulation and coding scheme (MCS) to the UE 104 for each of the TBs. In one example, the network node 102 may transmit the indications via RRC (e.g., via the optional first communication 1202). Alternatively, the network node 102 may transmit the indications via DCI (e.g., via the second communication 1204). In another example, the network node 102 may transmit an indication of an MCS for each TB to the UE 104, then dynamically change the MCSs as needed for future communications via DCI. In some examples, the network node 102 may transmit an indication of first MCS for a first TB, and an indication of a second MCS for a second TB. The indication of one or more of the first MCS and/or the second MCS may be an explicit indication of the first and/or second MCS (e.g., an index identifying a corresponding MCS in a table). Alternatively, the indication of the first MCS may be an explicit indication of the first MCS (e.g., an index identifying a corresponding MCS in a table), while the indication of the second MCS may be an offset value that the UE 104 is configured to add to the first MCS.

Accordingly, the network node 102 may transmit downlink signaling to the UE 104 via each TB using a different MCS for each TB. Thus, TB splitting may allow the network node 102 to improve throughput because the network node 102 has the opportunity to configure each TB according to conditions that affect that TB. For example, if TB1 is closer to the uplink subband than TB2, then TB1 may be subject to more interference relative to TB2. Accordingly, the network node 102 may assign a smaller MCS to TB1 than it assigns to TB2. Accordingly, the network node 102 may optimize downlink transmissions in order to reduce errors and retransmissions, thereby leading to a relatively higher reliability and higher throughput compared to TBs that use identical resources and are configured with identical MCSs. Thus, in certain aspects, the network node 102 may map a smaller MCS to a TB that is located closest to the uplink subband. The network node 102 may determine the MCS for each TB in the first process 1201.

At a second process 1206, the UE 104 may configure its receiver (e.g., RF configuration) according to the information provided by the network node 102. For example, the UE 104 configure its receiver for receiving separated TBs and MCSs associated with each of the separated TBs. At a third communication 1208, the network node 102 may transmit, and the UE 104 may receive, an SBFD slot configured with separated TBs, wherein the SBFD slot was scheduled by the DCI communication of the second communication 1204.

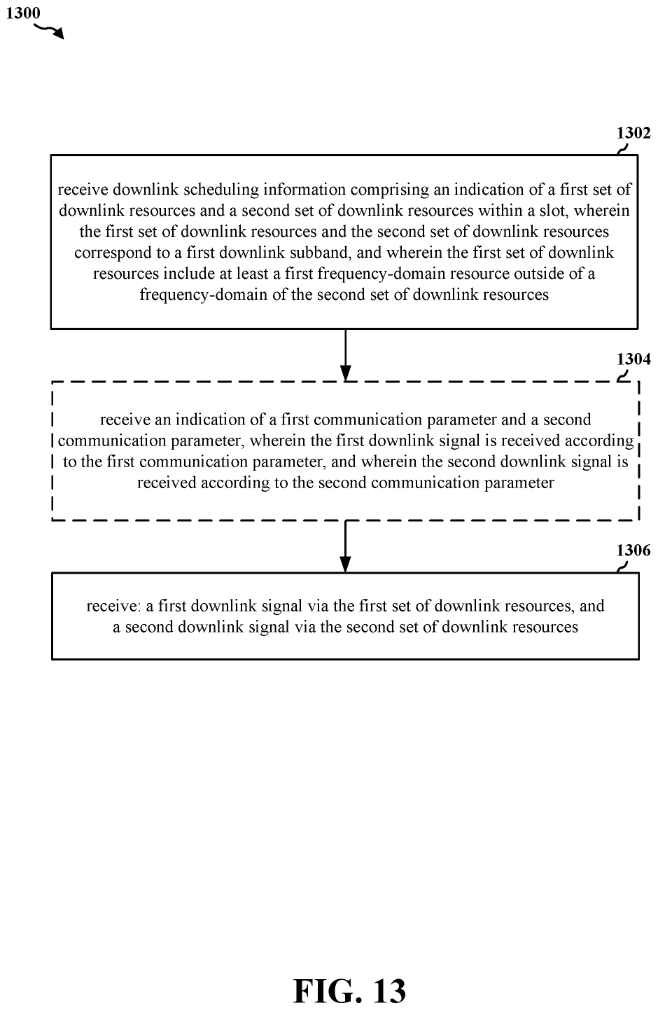

FIG. 13 is a flowchart 1300 of a method of wireless communication. The method may be performed by a UE (e.g., the UE 104; the apparatus 1402). At 1302, the UE may receive downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources, as illustrated by at least one of the optional first communication 1202 and/or the second communication 1204 of FIG. 12. For example, 1302 may be performed by a receiving component 1440. Here, the UE may receive downlink scheduling information that may include an FDRA or frequencyDomainAllocation IE indicating a TB region of a downlink subband. The TB region may include the entire subband region of a slot, or a portion of the subband region. The downlink scheduling information may also include an indication of how the TB region is split into two or more separate TBs or overlapping TBs. For example the first set of downlink resources may correspond to a first TB, and the second set of downlink resources may correspond to a second TB. In some examples, the downlink scheduling information may include an indication of a threshold number of RBs indicative of a number of RBs within the TB region starting at a boundary of the TB region closest to an uplink subband or guard band. Thus, the threshold number of RBs may indicate the resources of the first TB, and any remaining resources in the TB region may correspond to the resources of the second TB.

At 1304, the UE may optionally receive an indication of a first communication parameter and a second communication parameter, wherein the first downlink signal is received according to the first communication parameter, and wherein the second downlink signal is received according to the second communication parameter, as illustrated by at least one of the optional first communication 1202 and/or the second communication 1204 of FIG. 12. For example, 1304 may be performed by the receiving component 1440. Here, the network node 102 may transmit an indication of a one or more communication parameters, such as an MCS, a transmit power, etc., for a downlink transmission TB. Thus, the UE is aware of the separate or overlapping TB regions as well as the MCS/transmit power of the signaling associated with each of the TB regions. For example, the network node may transmit a signal in each TB region, wherein the signal of a first TB region has at least one communication parameter that is different from a communication parameter of the second TB region.

Finally, at 1306, the UE may receive: a first downlink signal via the first set of downlink resources, and a second downlink signal via the second set of downlink resources, as illustrated by the third communication 1208 of FIG. 12. For example, 1306 may be performed by the receiving component 1440.

In certain aspects, the slot is configured as a subband full duplex (SBFD) slot comprising the first downlink subband and at least one of a guard band or an uplink subband.

In certain aspects, the first set of downlink resources correspond to resources allocated to a first transport block (TB), wherein the second set of downlink resources correspond to resources allocated to a second TB, and wherein the first TB and the second TB are allocated within the first downlink subband.

In certain aspects, the first set of downlink resources are separate from the second set of downlink resources in the frequency-domain.

In certain aspects, the first set of downlink resources include at least a second frequency-domain resource within the frequency-domain of the second set of downlink resources.

In certain aspects, the downlink scheduling information is received via at least one of a radio resource control (RRC) message or a downlink control information (DCI) message.

In certain aspects, the indication of the first set of downlink resources and the second set of downlink resources comprises a threshold value indicative of an end of the first set of downlink resources and a start of the second set of downlink resources.

In certain aspects, the threshold value is at least one of a number of resource blocks (RBs) or an index mapped to the number of RBs via a table.

In certain aspects, the indication of the first set of downlink resources and the second set of downlink resources comprises an indication of a usable bandwidth within the first downlink subband, and a range within the usable bandwidth.

In certain aspects, the usable bandwidth comprises a plurality of resource blocks (RBs), and the range comprises a subset of the RBs, wherein the subset of the RBs is the first set of downlink resources, and wherein the second set of downlink resources is the usable bandwidth minus the subset of the RBs.

In certain aspects, the indication of the first set of downlink resources and the second set of downlink resources comprises an indication of a partition dividing the frequency-domain of the first downlink subband into a first subband region and a second subband region, wherein the first subband region is the first set of downlink resources, and wherein the second subband region is the second set of downlink resources.

In certain aspects, the first downlink signal is received via the first set of downlink resources and the second set of downlink resources.

In certain aspects, the indication of the first communication parameter and the second communication parameter are received via at least one of a radio resource control (RRC) message or a downlink control information (DCI) message.

In certain aspects, the indication of the first communication parameter and the second communication parameter includes a mapping between the first set of downlink resources and the first communication parameter, and a mapping between the second set of downlink resources and the second communication parameter.

In certain aspects, the first communication parameter is a first modulation coding scheme (MCS) of the first downlink signal, and wherein the second communication parameter is a second MCS of the second downlink signal, wherein the first set of downlink resources are adjacent to an uplink subband, and wherein the first MCS is smaller relative to the second MCS.

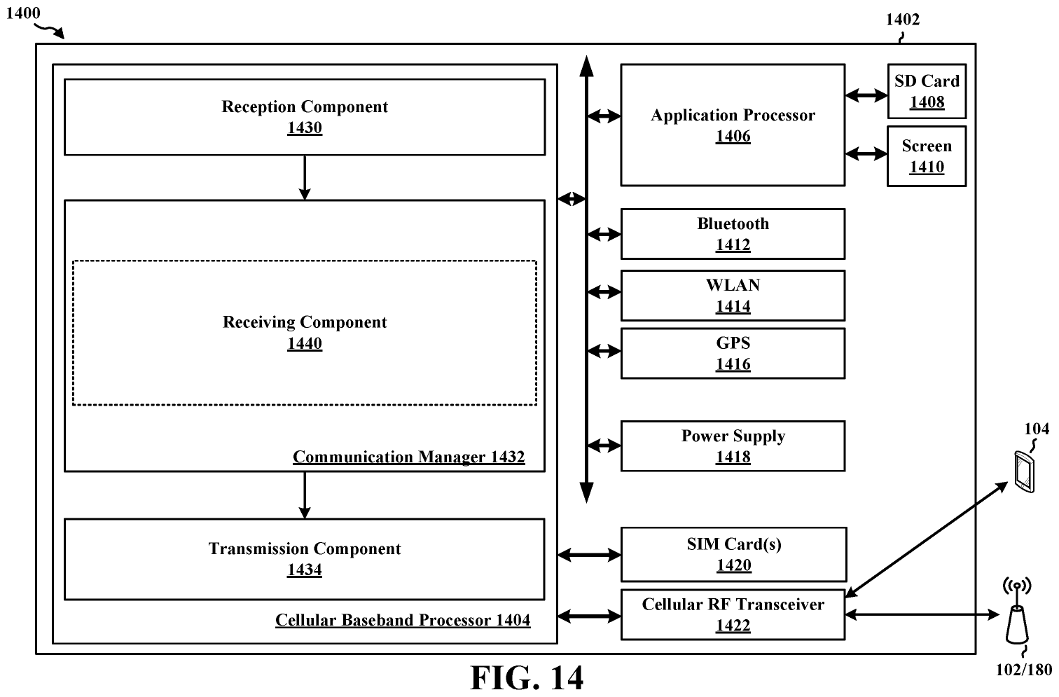

FIG. 14 is a diagram 1400 illustrating an example of a hardware implementation for an apparatus 1402. The apparatus 1402 is a UE and includes a cellular baseband processor 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 350 of FIG. 3) and include the aforediscussed additional modules of the apparatus 1402.

The communication manager 1432 includes a receiving component 1440 that is configured to receive downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; receive an indication of a first communication parameter and a second communication parameter, wherein the first downlink signal is received according to the first communication parameter, and wherein the second downlink signal is received according to the second communication parameter; and receive: a first downlink signal via the first set of downlink resources, and a second downlink signal via the second set of downlink resources e.g., as described in connection with 1302, 1304, and 1306 of FIG. 13.

The apparatus may include additional components that perform each of the blocks of the algorithm in the aforementioned flowchart of FIG. 13. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the cellular baseband processor 1404, includes: means for receiving downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; means for receiving an indication of a first communication parameter and a second communication parameter, wherein the first downlink signal is received according to the first communication parameter, and wherein the second downlink signal is received according to the second communication parameter; and means for receiving: a first downlink signal via the first set of downlink resources, and a second downlink signal via the second set of downlink resources.

The aforementioned means may be one or more of the aforementioned components of the apparatus 1402 configured to perform the functions recited by the aforementioned means. As described supra, the apparatus 1402 may include the RX Processor 356, one or more antennas 352, and the controller/processor 359. As such, in one configuration, the aforementioned means may be the RX Processor 356, one or more antennas 352, and the controller/processor 359 configured to perform the functions recited by the aforementioned means.

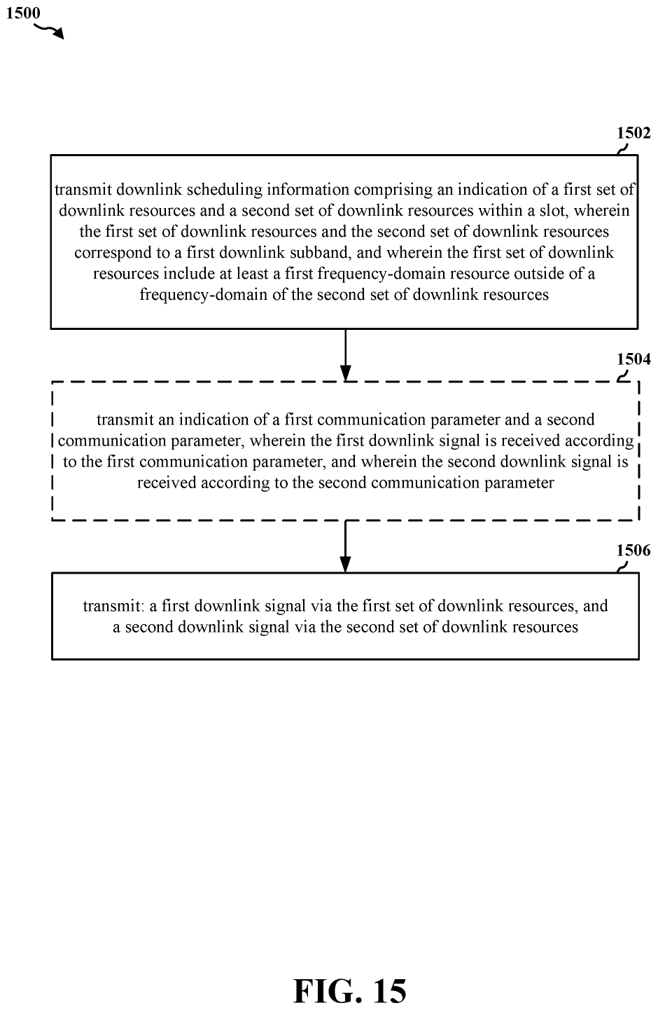

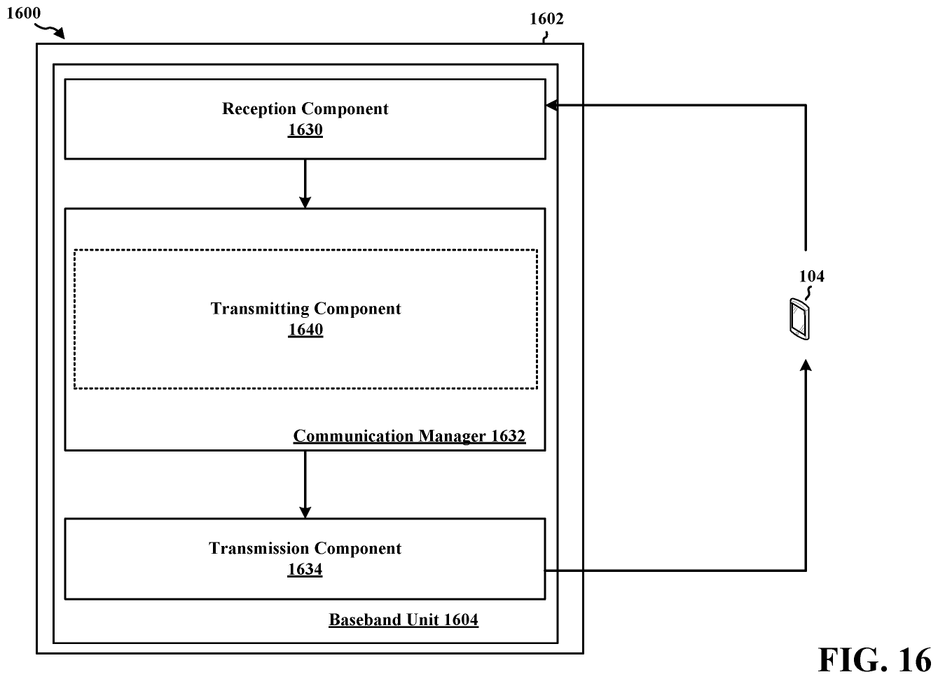

FIG. 15 is a flowchart 1500 of a method of wireless communication. The method may be performed by a base station (e.g., the base station 102/180; the apparatus 1602) or a network node of the base station (e.g., in the case of a disaggregated base station). At 1502, the base station may transmit downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources, as illustrated by at least one of the optional first communication 1202 and/or the second communication 1204 of FIG. 12. For example, 1502 may be performed by a transmitting component 1640 of FIG. 16.

At 1504, the base station may optionally transmit an indication of a first communication parameter and a second communication parameter, wherein the first downlink signal is received according to the first communication parameter, and wherein the second downlink signal is received according to the second communication parameter, as illustrated by at least one of the optional first communication 1202 and/or the second communication 1204 of FIG. 12. For example, 1504 may be performed by the transmitting component 1640 of FIG. 16.

Finally, at 1506, the base station may transmit: a first downlink signal via the first set of downlink resources, and a second downlink signal via the second set of downlink resources, as illustrated by the third communication 1208 of FIG. 12. For example, 1506 may be performed by the transmitting component 1640 of FIG. 16.

In certain aspects, the slot is configured as a subband full duplex (SBFD) slot comprising the first downlink subband and at least one of a guard band or an uplink subband.

In certain aspects, the first set of downlink resources correspond to resources allocated to a first transport block (TB), wherein the second set of downlink resources correspond to resources allocated to a second TB, and wherein the first TB and the second TB are allocated within the first downlink subband.

In certain aspects, the first set of downlink resources are separate from the second set of downlink resources in the frequency-domain.

In certain aspects, the first set of downlink resources include at least a second frequency-domain resource within the frequency-domain of the second set of downlink resources.

In certain aspects, the downlink scheduling information is received via at least one of a radio resource control (RRC) message or a downlink control information (DCI) message.

In certain aspects, the indication of the first set of downlink resources and the second set of downlink resources comprises a threshold value indicative of an end of the first set of downlink resources and a start of the second set of downlink resources.

In certain aspects, the threshold value is at least one of a number of resource blocks (RBs) or an index mapped to the number of RBs via a table.

In certain aspects, the indication of the first set of downlink resources and the second set of downlink resources comprises an indication of a usable bandwidth within the first downlink subband, and a range within the usable bandwidth.

In certain aspects, the usable bandwidth comprises a plurality of resource blocks (RBs), and the range comprises a subset of the RBs, wherein the subset of the RBs is the first set of downlink resources, and wherein the second set of downlink resources is the usable bandwidth minus the subset of the RBs.

In certain aspects, the indication of the first set of downlink resources and the second set of downlink resources comprises an indication of a partition dividing the frequency-domain of the first downlink subband into a first subband region and a second subband region, wherein the first subband region is the first set of downlink resources, and wherein the second subband region is the second set of downlink resources.

In certain aspects, the first downlink signal is transmitted via the first set of downlink resources and the second set of downlink resources.

FIG. 16 is a diagram 1600 illustrating an example of a hardware implementation for an apparatus 1602. The apparatus 1602 is a BS and includes a baseband unit 1604. The baseband unit 1604 may communicate through a cellular RF transceiver with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the BS 310 and may include the memory 376 and/or at least one of the TX processor 316, the RX processor 370, and the controller/processor 375.

The communication manager 1632 includes a transmitting component 1640 that configured to transmit downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; transmit an indication of a first communication parameter and a second communication parameter, wherein the first downlink signal is received according to the first communication parameter, and wherein the second downlink signal is received according to the second communication parameter; and transmit: a first downlink signal via the first set of downlink resources, and a second downlink signal via the second set of downlink resources; e.g., as described in connection with 1502, 1504, and 1506 of FIG. 15.

The apparatus may include additional components that perform each of the blocks of the algorithm in the aforementioned flowchart of FIG. 15. As such, each block in the aforementioned flowchart of FIG. 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the baseband unit 1604, includes means for transmitting downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; means for transmitting an indication of a first communication parameter and a second communication parameter, wherein the first downlink signal is received according to the first communication parameter, and wherein the second downlink signal is received according to the second communication parameter; and means for transmitting: a first downlink signal via the first set of downlink resources, and a second downlink signal via the second set of downlink resources. The aforementioned means may be one or more of the aforementioned components of the apparatus 1602 configured to perform the functions recited by the aforementioned means. As described supra, the apparatus 1602 may include the TX Processor 316 and the controller/processor 375. As such, in one configuration, the aforementioned means may be the TX Processor 316 and the controller/processor 375 configured to perform the functions recited by the aforementioned means.

### Additional Considerations

Means for receiving or means for obtaining may include a receiver, such as the receive processor 356/370 and/or an antenna(s) 320/352 of the BS 102/180 and UE 104 illustrated in FIG. 3. Means for transmitting or means for outputting may include a transmitter, such as the transmit processor 316/368 and/or an antenna(s) 320/352 of the BS 102/180 and UE 104 illustrated in FIG. 3. Means for estimating, means for determining, means for measuring, and/or means for performing may include a processing system, which may include one or more processors, such as the controller/processor 375/359 of the BS 102/180 and the UE 104 illustrated in FIG. 3.

As used herein, the terms “identifying” and/or “determining” (or any variants thereof such as “identify” and determine”) encompass a wide variety of actions. For example, “identifying” and/or “determining” may include calculating, computing, processing, deriving, investigating, looking up (e.g., looking up in a table, a database or another data structure), ascertaining and the like. Also, “identifying” and/or “determining” may include receiving (e.g., receiving information), accessing (e.g., accessing data in a memory) and the like. Also, “identifying” and/or “determining” may include resolving, selecting, choosing, establishing and the like.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a user equipment (UE), comprising: receiving downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and receiving: a first downlink signal via the first set of downlink resources, and a second downlink signal via the second set of downlink resources.

Example 2 is the method of example 1, wherein the slot is configured as a subband full duplex (SBFD) slot comprising the first downlink subband and at least one of a guard band or an uplink subband.

Example 3 is the method of any of examples 1 and 2, wherein the first set of downlink resources correspond to resources allocated to a first transport block (TB), wherein the second set of downlink resources correspond to resources allocated to a second TB, and wherein the first TB and the second TB are allocated within the first downlink subband.

Example 4 is the method of any of examples 1-3, wherein the first set of downlink resources are separate from the second set of downlink resources in the frequency-domain.

Example 5 is the method of any of examples 1-4, wherein the first set of downlink resources include at least a second frequency-domain resource within the frequency-domain of the second set of downlink resources.

Example 6 is the method of any of examples 1-5, wherein the downlink scheduling information is received via at least one of a radio resource control (RRC) message or a downlink control information (DCI) message.

Example 7 is the method of any of examples 1-6, wherein the indication of the first set of downlink resources and the second set of downlink resources comprises a threshold value indicative of an end of the first set of downlink resources and a start of the second set of downlink resources.

Example 8 is the method of any of examples 1-7, wherein the threshold value is at least one of a number of resource blocks (RBs) or an index mapped to the number of RBs via a table.

Example 9 is the method of any of examples 1-8, wherein the indication of the first set of downlink resources and the second set of downlink resources comprises an indication of a usable bandwidth within the first downlink subband, and a range within the usable bandwidth.

Example 10 is the method of any of examples 1-9, wherein the usable bandwidth comprises a plurality of resource blocks (RBs), and the range comprises a subset of the RBs, wherein the subset of the RBs is the first set of downlink resources, and wherein the second set of downlink resources is the usable bandwidth minus the subset of the RBs.

Example 11 is the method of any of examples 1-10, wherein the indication of the first set of downlink resources and the second set of downlink resources comprises an indication of a partition dividing the frequency-domain of the first downlink subband into a first subband region and a second subband region, wherein the first subband region is the first set of downlink resources, and wherein the second subband region is the second set of downlink resources.

Example 12 is the method of any of examples 1-11, wherein the first downlink signal is received via the first set of downlink resources and the second set of downlink resources.

Example 13 is the method of any of examples 1-12, wherein the method further comprises: receiving an indication of a first communication parameter and a second communication parameter, wherein the first downlink signal is received according to the first communication parameter, and wherein the second downlink signal is received according to the second communication parameter.

Example 14 is the method of example 13, wherein the indication of the first communication parameter and the second communication parameter are received via at least one of a radio resource control (RRC) message or a downlink control information (DCI) message.

Example 15 is the method of any of examples 13 and 14, wherein the indication of the first communication parameter and the second communication parameter includes a mapping between the first set of downlink resources and the first communication parameter, and a mapping between the second set of downlink resources and the second communication parameter.

Example 16 is the method of example 15, wherein the first communication parameter is a first modulation coding scheme (MCS) of the first downlink signal, and wherein the second communication parameter is a second MCS of the second downlink signal, wherein the first set of downlink resources are adjacent to an uplink subband, and wherein the first MCS is smaller relative to the second MCS.

Example 17 is a method of wireless communication at a network node, comprising: transmitting downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and transmitting: a first downlink signal via the first set of downlink resources, and a second downlink signal via the second set of downlink resources.

Example 18 is the method of example 17, wherein the slot is configured as a subband full duplex (SBFD) slot comprising the first downlink subband and at least one of a guard band or an uplink subband.

Example 19 is the method of any of examples 17 and 18, wherein the first set of downlink resources correspond to resources allocated to a first transport block (TB), wherein the second set of downlink resources correspond to resources allocated to a second TB, and wherein the first TB and the second TB are allocated within the first downlink subband.

Example 20 is the method of any of examples 17-19, wherein the first set of downlink resources are separate from the second set of downlink resources in the frequency-domain.

Example 21 is the method of any of examples 17-20, wherein the first set of downlink resources include at least a second frequency-domain resource within the frequency-domain of the second set of downlink resources.

Example 22 is the method of any of examples 17-21, wherein the downlink scheduling information is transmitted via at least one of a radio resource control (RRC) message or a downlink control information (DCI) message.

Example 23 is the method of any of examples 17-22, wherein the indication of the first set of downlink resources and the second set of downlink resources comprises a threshold value indicative of an end of the first set of downlink resources and a start of the second set of downlink resources.

Example 24 is the method of any of examples 17-23, wherein the threshold value is at least one of a number of resource blocks (RBs) or an index mapped to the number of RBs via a table.

Example 25 is the method of any of examples 17-24, wherein the indication of the first set of downlink resources and the second set of downlink resources comprises an indication of a usable bandwidth within the first downlink subband, and a range within the usable bandwidth.

Example 26 is the method of any of examples 17-25, wherein the usable bandwidth comprises a plurality of resource blocks (RBs), and the range comprises a subset of the RBs, wherein the subset of the RBs is the first set of downlink resources, and wherein the second set of downlink resources is the usable bandwidth minus the subset of the RBs.

Example 27 is the method of any of examples 17-26, wherein the indication of the first set of downlink resources and the second set of downlink resources comprises an indication of a partition dividing the frequency-domain of the first downlink subband into a first subband region and a second subband region, wherein the first subband region is the first set of downlink resources, and wherein the second subband region is the second set of downlink resources.

Example 28 is the method of any of examples 17-27, wherein the first downlink signal is transmitted via the first set of downlink resources and the second set of downlink resources.

Example 29 is a user equipment (UE) comprising: a memory; and a processor coupled to the memory, the processor and memory being configured to perform the method of any of examples 1-16.

Example 29 is a network node comprising: a memory; and a processor coupled to the memory, the processor and memory being configured to perform the method of any of examples 17-28.

Example 30 is a user equipment (UE) comprising: one or more means for performing the method of any of examples 1-16.

Example 31 is a network node comprising: one or more means for performing the method of any of examples 17-28.

Example 32 is a non-transitory computer-readable storage medium having instructions stored thereon for performing the method of any of claims 1-16 for wireless communication by a user equipment (UE).

Example 33 is a non-transitory computer-readable storage medium having instructions stored thereon for performing the method of any of claims 17-28 for wireless communication by a network node.

What is claimed is:

1. A user equipment (UE) configured for wireless communication, comprising:
a memory comprising instructions; and
one or more processors configured to execute the instructions and cause the UE to:
receive downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and
receive:
a first downlink signal via the first set of downlink resources, and
a second downlink signal via the second set of downlink resources.

2. The UE of claim 1, wherein the slot is configured as a subband full duplex (SBFD) slot comprising the first downlink subband and at least one of a guard band or an uplink subband.

3. The UE of claim 1, wherein the first set of downlink resources correspond to resources allocated to a first transport block (TB), wherein the second set of downlink resources correspond to resources allocated to a second TB, and wherein the first TB and the second TB are allocated within the first downlink subband.

4. The UE of claim 1, wherein the first set of downlink resources are separate from the second set of downlink resources in the frequency-domain.

5. The UE of claim 1, wherein the first set of downlink resources include at least a second frequency-domain resource within the frequency-domain of the second set of downlink resources.

6. The UE of claim 1, wherein the downlink scheduling information is received via at least one of a radio resource control (RRC) message or a downlink control information (DCI) message.

7. The UE of claim 1, wherein the indication of the first set of downlink resources and the second set of downlink resources comprises a threshold value indicative of an end of the first set of downlink resources and a start of the second set of downlink resources.

8. The UE of claim 7, wherein the threshold value is at least one of a number of resource blocks (RBs) or an index mapped to the number of RBs via a table.

9. The UE of claim 1, wherein the indication of the first set of downlink resources and the second set of downlink resources comprises an indication of a usable bandwidth within the first downlink subband, and a range within the usable bandwidth.

10. The UE of claim 9, wherein the usable bandwidth comprises a plurality of resource blocks (RBs), and the range comprises a subset of the RBs, wherein the subset of the RBs is the first set of downlink resources, and wherein the second set of downlink resources is the usable bandwidth minus the subset of the RBs.

11. The UE of claim 1, wherein the indication of the first set of downlink resources and the second set of downlink resources comprises an indication of a partition dividing the frequency-domain of the first downlink subband into a first subband region and a second subband region, wherein the first subband region is the first set of downlink resources, and wherein the second subband region is the second set of downlink resources.

12. The UE of claim 11, wherein the first downlink signal is received via the first set of downlink resources and the second set of downlink resources.

13. The UE of claim 1, wherein the one or more processors are further configured to cause the UE to:
receive an indication of a first communication parameter and a second communication parameter, wherein the first downlink signal is received according to the first communication parameter, and wherein the second downlink signal is received according to the second communication parameter.

14. The UE of claim 13, wherein the indication of the first communication parameter and the second communication parameter are received via at least one of a radio resource control (RRC) message or a downlink control information (DCI) message.

15. The UE of claim 13, wherein the indication of the first communication parameter and the second communication parameter includes a mapping between the first set of downlink resources and the first communication parameter, and a mapping between the second set of downlink resources and the second communication parameter.

16. The UE of claim 15, wherein the first communication parameter is a first modulation coding scheme (MCS) of the first downlink signal, and wherein the second communication parameter is a second MCS of the second downlink signal, wherein the first set of downlink resources are adjacent to an uplink subband, and wherein the first MCS is smaller relative to the second MCS.

17. A network node configured for wireless communication, comprising:
a memory comprising instructions; and
one or more processors configured to execute the instructions and cause the network node to:
transmit downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and
transmit:
a first downlink signal via the first set of downlink resources, and
a second downlink signal via the second set of downlink resources.

18. The network node of claim 17, wherein the slot is configured as a subband full duplex (SBFD) slot comprising the first downlink subband and at least one of a guard band or an uplink subband.

19. The network node of claim 17, wherein the first set of downlink resources correspond to resources allocated to a first transport block (TB), wherein the second set of downlink resources correspond to resources allocated to a second TB, and wherein the first TB and the second TB are allocated within the first downlink subband.

20. The network node of claim 17, wherein the first set of downlink resources are separate from the second set of downlink resources in the frequency-domain.

21. The network node of claim 17, wherein the first set of downlink resources include at least a second frequency-domain resource within the frequency-domain of the second set of downlink resources.

22. The network node of claim 17, wherein the downlink scheduling information is received via at least one of a radio resource control (RRC) message or a downlink control information (DCI) message.

23. The network node of claim 17, wherein the indication of the first set of downlink resources and the second set of downlink resources comprises a threshold value indicative of an end of the first set of downlink resources and a start of the second set of downlink resources.

24. The network node of claim 23, wherein the threshold value is at least one of a number of resource blocks (RBs) or an index mapped to the number of RBs via a table.

25. The network node of claim 17, wherein the indication of the first set of downlink resources and the second set of downlink resources comprises an indication of a usable bandwidth within the first downlink subband, and a range within the usable bandwidth.

26. The network node of claim 25, wherein the usable bandwidth comprises a plurality of resource blocks (RBs), and the range comprises a subset of the RBs, wherein the subset of the RBs is the first set of downlink resources, and wherein the second set of downlink resources is the usable bandwidth minus the subset of the RBs.

27. The network node of claim 17, wherein the indication of the first set of downlink resources and the second set of downlink resources comprises an indication of a partition dividing the frequency-domain of the first downlink subband into a first subband region and a second subband region, wherein the first subband region is the first set of downlink resources, and wherein the second subband region is the second set of downlink resources.

28. The network node of claim 27, wherein the first downlink signal is received via the first set of downlink resources and the second set of downlink resources.

29. A method for wireless communication at a user equipment (UE), comprising:
receiving downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and
receiving:
a first downlink signal via the first set of downlink resources, and
a second downlink signal via the second set of downlink resources.

30. A method for wireless communication at a network node, comprising:
transmitting downlink scheduling information comprising an indication of a first set of downlink resources and a second set of downlink resources within a slot, wherein the first set of downlink resources and the second set of downlink resources correspond to a first downlink subband, and wherein the first set of downlink resources include at least a first frequency-domain resource outside of a frequency-domain of the second set of downlink resources; and
transmitting:
a first downlink signal via the first set of downlink resources, and
a second downlink signal via the second set of downlink resources.
